(19) United States
(12) Patent Application Publication
(10) Pub. No.: US 2004/0202533 A1
(43) Pub. Date: Oct. 14, 2004

(54) Bed containment system for vehicles

(76) Inventor: A. Ralph Haire, Thomasville, NC (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/409,655

(22) Filed: Apr. 8, 2003

(51) Int. Cl. B60P 1/00

(52) U.S. Cl. 414/538

(57) ABSTRACT

There is provided a bed containment system disposed in a vehicle for convenient loading, securing, and unloading of a bed such as those used in the hospital or nursing home industries. A winch with a cable is provided to attach to the bed and to pull the bed up a loading ramp and onto a support surface. The bed is positioned on the support surface while the bed is within the vehicle. The cable remains attached to the bed while the bed is within the vehicle to secure against longitudinal movement of the bed during transport. The support surface inclines downward from a forward edge to an aft edge. A securing member within the vehicle includes at least one arm that is laterally moveable against a side of the bed to secure the bed against lateral movement. The bed is removed by disengaging the arm and reversing the winch such that the bed rolls rearward down the inclined support surface and down the loading ramp. Remote controls are provided near the loading ramp such that the bed may be loaded, secured, and unloaded without requiring the operator to climb into the vehicle.

### FIELD OF THE INVENTION

The present invention relates generally to a system for transporting beds. More specifically, the present invention relates to a winch, loading ramp, inclined support surface, and securing member that provide convenient loading, securing, and unloading of a bed into or out of a vehicle.

### BACKGROUND OF THE INVENTION

Within the hospital and nursing home industry, many of the patient beds are not owned by the hospital or nursing home. Instead, the beds are rented items that are often prescribed by doctors. Beds are chosen so that, for example, a certain type of patient may be prescribed a type of bed that caters best to the injury or illness of the patient. Private companies fulfill these bed prescriptions and, as such, will deliver and remove beds from the hospitals and nursing homes accordingly. Thus it is important that the bed rental company be able to quickly deliver and remove the prescribed beds.

Conventional trucks for delivery of patient beds comprise a closed truck body having a ramp that can be extended from the back of the truck body. However, these patient beds can be very heavy and require the delivery personnel to push the bed up the ramp and into the truck body. This process is laborious and may require two people to travel with the truck so that heavy beds can be properly loaded.

After the bed is placed into the truck body, one or more ratchet straps must be fastened between the bed and the truck body and then tightened so as to secure the bed within the body and stop the bed from rolling around while the truck is moving. This process is also labor intensive.

Therefore, a need exists for a system for convenient loading and unloading of a bed into and out of a truck and for convenient securing of the bed within the truck.

### BRIEF SUMMARY OF THE INVENTION

The invention addresses the above needs and achieves other advantages by providing a bed containment system for loading a bed into a vehicle, securing the bed within the vehicle, and unloading the bed from the vehicle. The system includes a loading ramp, a support surface, a winch and cable, and a securing member. To load the bed into the vehicle, the cable is attached to the bed and the winch pulls the bed up the loading ramp and onto the support surface that slopes downward from front to back. To secure the bed within the vehicle, a securing member comprising at least one movable arm is provided over the support surface to laterally restrain the loaded bed. To unload the bed, the movable arm is moved away from the bed to release the bed, and as the winch is unwound, the bed will slowly roll back off the support surface and down the loading ramp. As such, it is possible for an operator to load, secure, and unload the bed without entering the vehicle.

In one embodiment of the system, the securing member comprises first and second arms that are connected to a forward member of the securing member by hinged attachments. In a further embodiment, the first and second arms are each laterally moved with an individual actuator positioned between the hinged attachment and the aft edge of each arm. The winch is positioned proximate the forward member of the securing member and a forward end of the support surface. In one embodiment, an opening is provided in the forward member of the securing member through which the cable passes so that when the bed is fully loaded the bed engages the forward member. A hook mechanism is included with the cable in a further embodiment of the system. Remote controls near the rear of the vehicle are also provided for convenient operation of the winch and actuators.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is a perspective view of the bed containment system with the loading ramp down and the cable attached to the bed;

FIG. 2 is a perspective view of the bed containment system;

FIG. 3 is a top view of the bed containment system without the bed loaded;

FIG. 4 is a top partial view of the bed containment system detailing the hinged attachment of an arm of the securing member;

FIG. 5 is a top view of the bed containment system with the bed loaded but not laterally secured; and

FIG. 6 is a top view of the bed containment system with the bed loaded and laterally secured.

### DETAILED DESCRIPTION OF THE INVENTION

The present invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout.

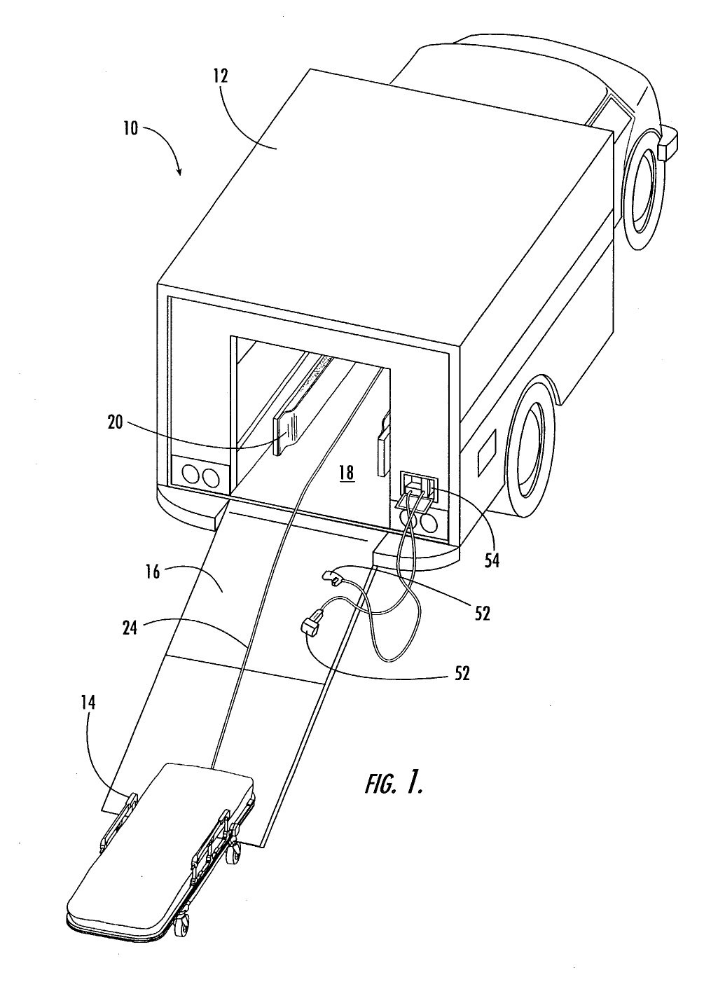

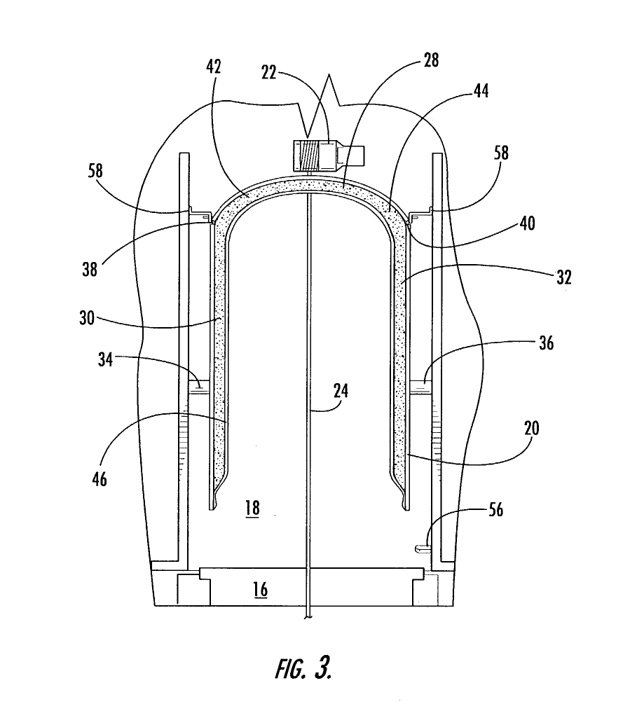

FIG. 1 illustrates the bed containment system 10 prior to loading of the bed 14 into the vehicle 12. The bed containment system 10 includes a loading ramp 16, a support surface 18, a securing member 20, a winch 22 with a cable 24, and remote controls 52. The winch 22 is shown in FIG. 3. As shown in FIG. 1, the bed containment system 10 is disposed within a vehicle 12 for convenient loading of a bed 14 into the vehicle, for secured support of the bed in the vehicle during transport, and for convenient unloading of the bed from the vehicle. The embodiment illustrated in FIG. 1 conveniently enables an individual operator to load a bed into, secure a bed within, and unload a bed from a vehicle 12 without requiring the operator to climb into the vehicle.

The support surface 18 is advantageously located near the rear of a vehicle 12 and is accessible through a rear door of the vehicle; however, the support surface may also be accessible through a side door in other embodiments of the present invention. The support surface 18 is preferably a flat surface, though other features may be included on the support surface, with non-limiting examples being ridges, channels, friction surfaces, grooves, or humps. The support surface 18 is inclined such that it slopes downward from a forward end to an aft end, the aft end being disposed near a rear door of the vehicle 12 and the loading ramp 16. The incline of support surface 18 allows a loaded bed 14 that is being removed to roll rearwards and out of the vehicle 12 when the winch 22 is activated to unwind the cable 24. The grade of the incline of the support surface 18 should be just steep enough to cause the bed 14 to roll rearward down the support surface when a forward force provided by the winch 22 is removed. Assuming the vehicle 12 is parked horizontally, the bed 14 rolls rearward because of gravity. The winch 22 also restrains the bed 14 from rolling too quickly down the support surface 18 or the loading ramp 16.

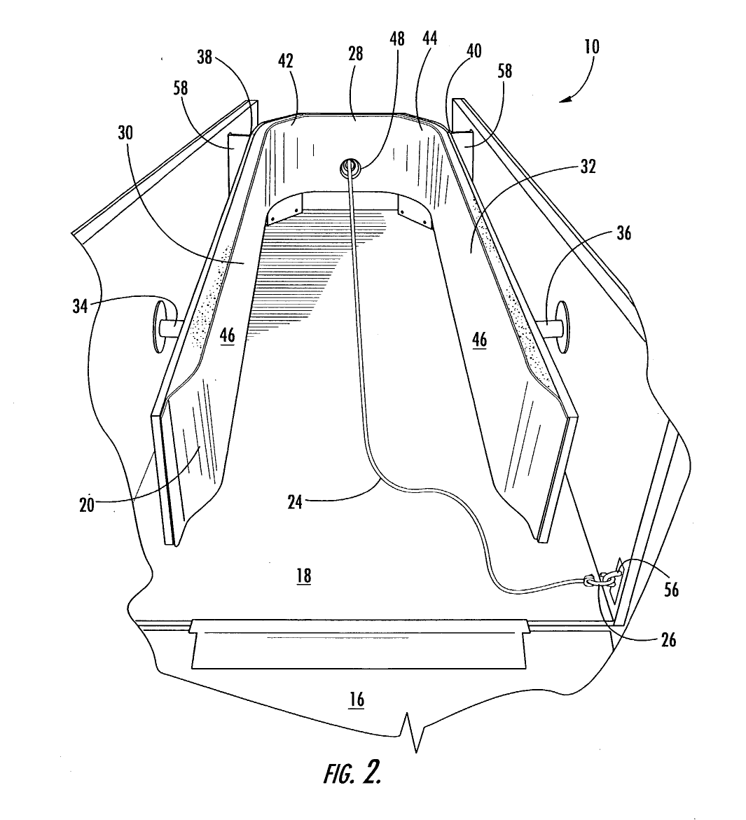

The loading ramp 16 is disposed immediately aft of the support surface 18 proximate the aft end of the support surface. The loading ramp 16, which is a separate component from the support surface 18, as shown in FIG. 2, extends rearward from the support surface and rests upon whatever surface the bed is supported on or will be unloaded onto. Non-limiting examples of such surfaces are loading docks, sidewalks, porches, or the ground. The loading ramp 16 is preferably a flat surface robust enough to support the weight of the bed and may include any surface features or designs as required. When the loading ramp 16 is not in use, it may be disconnected and stored separate from the bed containment system 10, may be slid under the support member 18, or may be rotated upwards to function as the rear door of the vehicle 12, to list a few non-limiting examples. However, during loading and unloading of the bed 14, the ramp 16 is advantageously positioned in the orientation shown in FIG. 1 and FIG. 2.

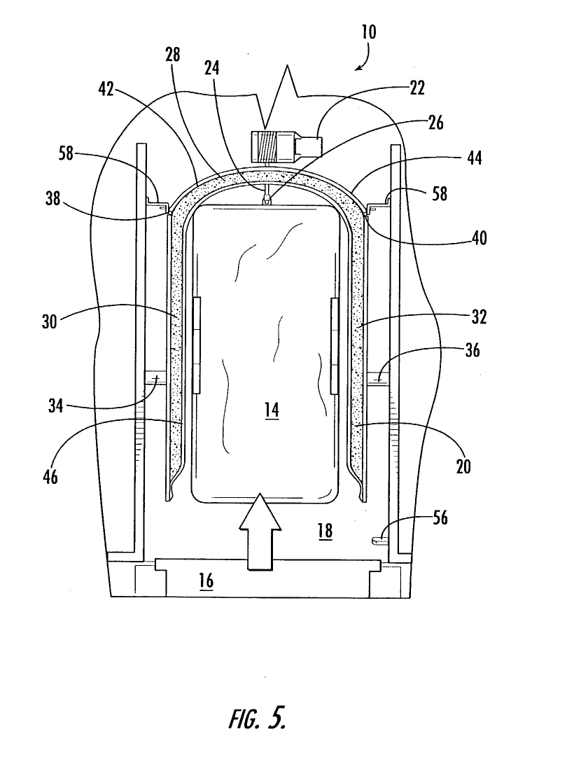

In FIG. 3, the winch 22 is located proximate the forward end of the support surface 18. The cable 24 extends rearward from the winch 22 over the support surface 18 and the loading ramp 16 to connect to the bed 14, as shown in FIG. 1. A cable length of 50 feet has been found to be sufficient and the cable 24 may be a rope, a strap, a metal cable, or a chain, to list a few non-limiting examples. The cable 24 includes a hook mechanism 26 at the end of the cable opposite the winch 22. The hook mechanism 26 is used to attach the cable 24 to the bed 14, as shown in FIG. 5, and advantageously consists of a hook for insertion into a hook retaining eyelet on the bed, but the hook mechanism may consist of any connection device. As shown in FIG. 2, a ring 56 is also provided in the vehicle 12 proximate the aft end of the support surface 18 to which the hook mechanism 26 may be attached when the bed containment system 10 is not in use. The ring 56 is positioned near the compartment 54, as illustrated in FIG. 1, where the remote controls 52 are stored so that when an operator retrieves the remote controls 52 he or she may also grasp the hook mechanism 26 of cable 24 without climbing into the vehicle 12.

As shown in FIG. 1, to load the bed 14 into the vehicle 12 the operator initially positions the bed near the bottom of the loading ramp 16, the bottom being the end of the loading ramp opposite the end proximate the aft end of the support surface 18. The bed 14 is shown is shown in FIG. 1 in a lowered position, but the bed could also be loaded in a raised position. The operator then disconnects the hook mechanism 26 from the ring 56 and removes the remote controls 52 from the compartment 54. Using the remote controls 52, the operator unwinds the winch 22 a sufficient length so that the cable 24 may reach the bed 14. Once the hook mechanism 26 is connected to the bed 14, the operator activates the winch 22 using the remote controls 52 to wind the cable 24 into the winch, thus pulling the bed 14 up the loading ramp 16 and onto the support surface 18. The winch 22 will continue pulling the bed 14 toward the winch 22 until the bed engages the securing member 20 proximate a forward member 28 or curved portions 42 and 44, as shown in FIG. 5. The cable 24 is then drawn tight and the operator may deactivate the winch 22 using the remote controls 52. At that point the bed 14 is longitudinally secured within the vehicle 12 because the tension in the cable 24 provides sufficient force to prevent the bed 14 from rolling down the incline of the support surface 18.

In the illustrated embodiment of FIG. 2, the securing member 20 includes a forward member 28, a first arm 30, and a second arm 32. Other embodiments of the present invention may include a securing member 20 with any combination of the three components, non-limiting examples being a first arm 30 only or a forward member 28 and a first arm 30. The forward member 28 is advantageously disposed proximate the forward end of the support surface 18 and proximate the winch 22. The forward member 28 shown in FIG. 2 includes an opening 48 for the cable 24 of winch 22 to pass through the securing member 20. Other embodiments of the present invention may have the cable 24 passing above, below, or in other configurations relative to the securing member 20. The forward member 28 generally extends in a lateral direction and in FIG. 2 intersects on one end with the first arm 30 and on the opposite end with second arm 32. The intersection of first arm 30 with the forward member 28 includes a first curved portion 42 and the intersection of second arm 32 with the forward member includes a second curved portion 44. However, other embodiments may include intersections between the forward member 28 and the arms 30 and 32 that form a right angle, an acute angle, an obtuse angle, a multi-angled intersection, or no intersection at all. Likewise, some embodiments may not even include a forward member 28 or a second arm 32.

In the embodiment shown in FIG. 3, the first arm 30 generally extends perpendicular to the forward member 28 in a longitudinal direction and terminates in an aft edge proximate the aft end of support surface 18. The second arm 32 also generally extends perpendicular to the forward member 28 in a longitudinal direction and terminates in an aft edge such that the first arm 30 and second arm 32 are generally parallel to each other when the arms are not actuated. Other embodiments may provide the first arm 30 oriented in any relation to the forward member 28 or the second arm 32. Therefore, as shown in FIG. 3, the securing member 20 generally forms a U-shaped enclosure for receiving the bed 14. The U-shaped enclosure is defined by the forward member 28, the first arm 30, and the second arm 32; but the U-shaped enclosure may include, but does not necessarily include, their respective intersections or the curved portions 42 and 44.

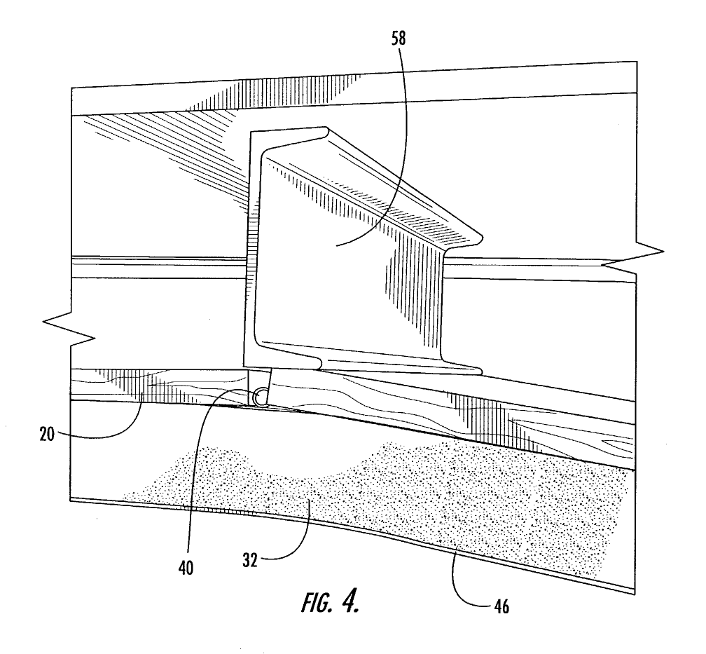

The securing member 20 is located at any height relative to the support surface 18 or defines any vertical width required by the bed 14 intended to be loaded into the vehicle 12. As shown in FIG. 4, the securing member 20 is connected to the interior of the vehicle 12 with supports 58. However, securing member 20 may be supported by any fashion in other embodiments of the present invention, which include but are not limited to resting the securing member upon the support surface 18 or fastening the securing member to the interior the vehicle 12.

The securing member 20 shown in FIG. 2 includes a padded interior surface 46 along each of the segments facing inwardly to minimize or prevent damage to the bed 14 or the securing member when the two come into contact. The padded interior surface 46 consists of any material that will not be significantly damaged by a bed 14 or that will not cause significant damage to a bed through repeated contact, some non-limiting examples being rubber, plastic, or foam material surrounded by a thin plastic sheet. The aft edges of the first arm 30 and the second arm 32 proximate the aft end of the support surface 18, which define the ends of the first arm and the second arm opposite the end intersecting with the forward member 28, include a tapered lead-in of the padded interior surface 46. The tapered lead-in enables the bed 14 to be more precisely loaded within the securing member 20 without damaging the bed or the securing member 20. Other embodiments may use other materials to provide a buffer between the bed 14 and the securing member 20 or use no buffer at all.

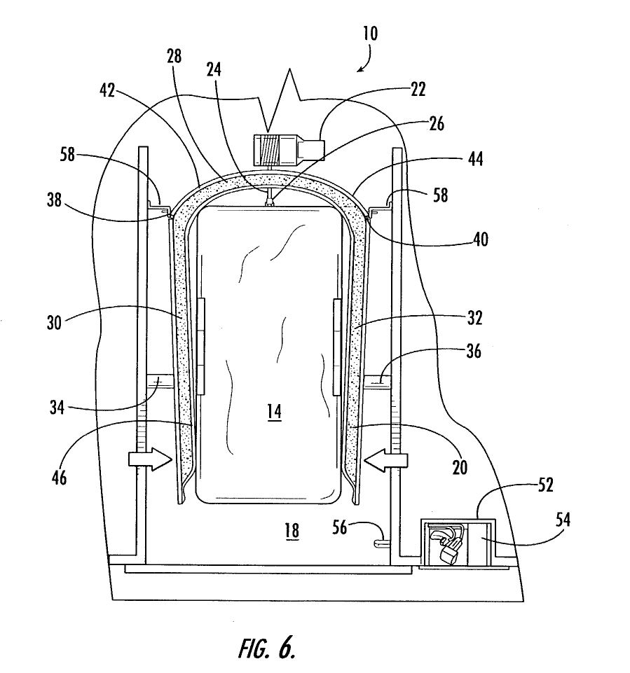

As shown in FIG. 3, the first arm 30 is attached to the first curved portion 42 with a first hinged attachment 38 and the second arm 32, which is also illustrated in FIG. 4, is attached to the second curved portion 44 with a second hinged attachment 40. The hinged attachments 38 and 40 are each a hinge with a vertical central axis that pivotally enables the first arm 30 and second arm 42, respectively, to move laterally toward the center of the vehicle 12, thus toward a loaded bed 14. Likewise, each arm may also be moved laterally away from the center of the vehicle 12 or away from a loaded bed 14. FIG. 5 illustrates the first arm 30 and the second arm 32 each in a non-actuated position oriented substantially longitudinal, or perpendicular to the forward member 28, such that the arms do not contact the loaded bed 14. However, the arms 30 and 32 may be laterally moved toward the loaded bed 14 when they are rotated about their respective hinged attachments 38 and 40 such that the arms contact the loaded bed 14, as shown in the actuated position illustrated in FIG. 6. In such a manner, loaded bed 14 may be laterally restrained so that lateral motion is minimized during transport within the vehicle.

Rather than using a hinged attachment 38 or 40 as shown in FIG. 3, other embodiments of the present invention may attach the arms 30 and 32 to the forward member 28 or to the vehicle 12 using other devices that allow the arms to be moved laterally so that they may engage a loaded bed 14 to laterally restrain the bed. Non-limiting examples would be linkages to move the arms 30 and 32 laterally, springs to bias the arms laterally inward, or other mechanical devices.

As shown in FIG. 3, a first actuator 34 and second actuator 36 are provided to laterally move the first arm 30 and second arm 32, respectively. The first actuator 34 is advantageously located along the longitudinal length of first arm 30 somewhere between the first hinged attachment 38 and the aft edge of the first arm. Likewise, the second actuator 36 is advantageously located along the longitudinal length of the second arm 32 somewhere between the second hinged attachment 40 and the aft edge of the second arm. As illustrated in FIG. 2, the actuators 34 and 36 are connected to the interior of the vehicle 12 so that they may move the arms 30 and 32, respectively, relative to the support surface 18 and the loaded bed 14. However, the actuators 34 and 36 may be anchored to the vehicle 12 by any feature of the bed containment system 10.

The actuators 34 and 36 of FIG. 2 each consist of a hydraulic cylinder controlled by the remote controls 52; however, other embodiments may include other varieties of actuators, such devices include but are not limited to jack screws, cams, or rack and pinion gears. Therefore, actuation of the actuators 34 and 36 may move the arms 30 and 32, respectively, laterally toward a loaded bed 14 and away from a loaded bed. When the padded interior surface 46 of the arms 30 and 32 engages the bed 14, the bed is restrained from lateral movement, and when the padded interior surface of the arms disengages the bed, the bed is free to move laterally. The first actuator 34 and the second actuator 36 advantageously move simultaneously and at equal speeds and distances so that a loaded bed 14 that is centered on the support surface 18 is equally engaged by both the first arm 30 and the second arm 32. Equivalent amounts of force exerted on each of the opposed sides of the bed 14 provide a reliable lateral restraint.

The bed containment system 10 is advantageously configured so that when the first arm 30 and the second arm 32, are actuated toward the loaded bed and the actuation is discontinued, the arms will maintain a force against the loaded bed 14. While the first arm 30 and second arm 32 are exerting force on the loaded bed 14, the arms are not free to move laterally until the operator actuates the arms in the opposite direction to release the bed. The actuated position is defined when the first arm 30 and the second arm 32 have been laterally moved inward, as shown in FIG. 6, such that the first arm 30 and the second arm 32 converge toward each other as they extend rearward. The non-actuated position shown in FIG. 5 defines the arms 30 and 32 running generally parallel to one another.

The remote controls 52 that control the winch 22 and the actuators 34 and 36 together are stored in a compartment 54. As illustrated in FIG. 1, the compartment 54 is mounted on the vehicle 12 near the rear door of the vehicle so that the operator using the bed containment system 10 may stand near the system while the bed is being loaded and unloaded and is not required to climb into the vehicle 12. The controls 52 may be on the end of long cords, such as 30 feet in length, to ease use by the operator, or the controls may alternatively be switches or knobs mounted to the exterior of the vehicle 12 or within the compartment 54. In one embodiment, a single remote control 52 may provide control for the winch and actuators. The compartment 54 as shown in FIG. 6 includes a door so that the remote controls 52 can be safely and conveniently stored within the compartment.

Once the bed 14 has been fully loaded onto the support surface 18, the winch 22 is deactivated using the remote controls 52. The securing member 20 may then be actuated using the remote controls 52 to laterally move the first arm 30 and the second arm 32 toward the center of the support surface 18 such that the first arm and the second arm engage a side of the bed 14 to laterally secure the bed. When the operator stops the actuation of the first arm 30 and the second arm 32, the arms remain in position thus maintaining a clamping force on the bed 14. The bed 14 is thus fully secured and the remote controls 52 may be returned to the compartment 54 and the loading ramp 16 removed or stored. The vehicle 12 is thus ready to transport the bed 14.

An alternative embodiment of the present invention may include a securing member 20 without a second arm 32 and its corresponding components. The bed 14 can be secured using one moveable arm 30 if a stationary surface is provided on the opposite side of the bed to prevent the bed from moving away from the arm 30. Therefore, a second arm 32 may be moveable, may be stationary, or may not be included in various embodiments of the present invention.

Unloading the bed 14 after it has been transported is essentially the reverse of the loading method. The operator must position the loading ramp 16 proximate the aft end of the support surface 18 and rest the loading ramp on the surface onto which the bed 14 will be unloaded. The rear door, if available, is opened to allow the bed 14 to pass through, and the remote controls 52 are removed from the compartment 54. The first actuator 34 and second actuator 36 are actuated using the remote controls 52 to laterally move the first arm 30 and second arm 32, respectively, away from the bed 14. Once the first arm 30 and second arm 32 are completely disengaged from the bed 14, the actuation may stop and the winch 22 may be activated to allow the cable 24 to unwind from the winch. As the cable 24 is unwound from the winch 22, the bed 14 rolls rearwardly down the downward sloping support surface 18 onto the loading ramp 16 and finally onto the surface on which the loading ramp 16 is positioned. Once the bed 14 is no longer supported by the support surface 18 or loading ramp 16, activation of the winch 22 may be stopped and the hook mechanism 26 may be disconnected from the bed 14 and connected to the ring 56, at which point the bed is freely movable. The operator may activate the winch 22 to wind the slack in the cable 24 into the winch to make the cable taut if desired by the operator. After the winch 22 is deactivated, the remote controls 52 may be returned to the compartment 54. The final steps are removing or storing the loading ramp 16 and closing the rear door of the vehicle 12.

Many modifications and other embodiments of the invention set forth herein will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A bed containment system for loading, securing, and unloading a bed having opposed sides in a vehicle, comprising:
a support surface within the vehicle having a forward end and an aft end, said forward end being positioned at a higher elevation than said aft end so that said support surface slopes downward from said forward end to said aft end;
a loading ramp proximate said aft end of said support surface that extends in a rearward direction from said aft end of said support surface;
a winch having a cable for securing to the bed, said cable extending from said forward end of said support surface in a rearward direction beyond said aft end of said support surface so that the bed can be winched up said loading ramp and onto said support surface; and
a securing member for securing the bed in the vehicle when the bed is on said support surface, said securing member comprising at least one arm that is laterally movable and capable of laterally moving against a side of the bed to secure the bed against movement when the vehicle is in motion.

2. A bed containment according to claim 1, wherein said securing member includes a forward member proximate said forward end of said support surface, and wherein said arm extends longitudinally from said forward member to an aft edge of said arm proximate said aft end of said support surface.

3. A bed containment according to claim 2, wherein said arm includes a hinged attachment such that said arm is laterally moveable about said hinged attachment.

4. A bed containment according to claim 3, wherein said arm includes an actuator longitudinally disposed between said hinged attachment and said aft edge of said arm to provide a lateral movement of said arm.

5. A bed containment system according to claim 4, wherein said securing member further comprises a second arm extending laterally from said forward member to an aft edge of said second arm proximate said aft end of said support surface, said second arm being laterally movable and capable of laterally moving against a side of the bed opposite the side of the bed engaged by said first arm to secure the bed against lateral movement when the vehicle is in motion.

6. A bed containment system according to claim 5, wherein said second arm includes a second hinged attachment and a second actuator, said second hinged attachment being disposed such that said second arm is laterally moveable about said second hinged attachment and said second actuator being disposed between said second hinged attachment and said aft edge of said second arm to provide a lateral movement of said second arm.

7. A bed containment system according to claim 6, wherein said first arm and said second arm extend generally parallel to each other in a non-actuated position and wherein said first arm and said second arm converge toward each other in an actuated position.

8. A bed containment system according to claim 5, wherein said first arm and said second arm include a padded surface facing the bed.

9. A bed containment system according to claim 5, wherein said first arm, said second arm, and said forward member define a U-shaped enclosure, said U-shaped enclosure includes a first curved portion at the intersection between said first arm and said forward member and a second curved portion at the intersection between said second arm and said forward member.

10. A bed containment system according to claim 1, wherein a remote control is included to activate said winch and to actuate said securing member.

11. A bed containment system according to claim 10 wherein a compartment is included on the vehicle, proximate the aft end of said support member, for storing said remote control when said remote control is not in use.

12. A bed containment system according to claim 1, wherein said cable includes a hook mechanism for attaching to the bed.

13. A bed containment system according to claim 1, wherein said loading ramp is structured and arranged to extend rearward from said support surface to an external surface outside the vehicle that supports the bed prior to or subsequent to said cable of said winch being attached to the bed.

14. A bed containment system for loading, securing, and unloading a bed having opposed sides in a vehicle, comprising:
a support surface within the vehicle having a forward end and an aft end, said forward end being positioned at a higher elevation than said aft end so that said support surface slopes downward from said forward end to said aft end;
a loading ramp proximate said aft end of said support surface that extends in a rearward direction from said aft end of said support surface;
a winch having a cable for securing to the bed, said cable extending from said forward end of said support surface in a rearward direction beyond said aft end of said support surface so that the bed can be winched up said loading ramp and onto said support surface;
a securing member for securing the bed in the vehicle when the bed is on said support surface, said securing member comprising a forward member proximate said forward end of said support surface, a first arm extending longitudinally from said forward member to an aft edge of said first arm proximate said aft end of said support surface, and a second arm extending longitudinally from said forward member to an aft edge of said second arm proximate said aft end of said support surface, such that said first arm and said second arm are generally parallel to each other and are generally perpendicular to said forward member; and
wherein said first arm and said second arm are each laterally movable and capable of laterally moving against opposed sides of the bed to secure the bed against movement when the vehicle is in motion.

15. A bed containment system according to claim 14, wherein said first arm includes a first hinged attachment such that said first arm is laterally moveable about said first hinged attachment, and said first arm includes a first actuator longitudinally disposed between said first hinged attachment and said aft edge of said first arm to provide a lateral movement of said first arm; and
wherein said second arm includes a second hinged attachment such that said second arm is laterally moveable about said second hinged attachment, and said second arm includes a second actuator longitudinally disposed between said second hinged attachment and said aft edge of said second arm to provide a lateral movement of said second arm.

16. A method of facilitating transportation of a bed with opposed sides in and out of a vehicle, comprising the steps of:
attaching the bed to a cable extending from a winch;
activating said winch to pull the bed up a loading ramp and onto a support surface having a forward end and an aft end, said forward end being positioned at a higher elevation than said aft end so that said support surface slopes downward from said forward end to said aft end;
leaving said cable attached to the bed while the bed is on said support surface; and
actuating a securing member in a lateral direction to engage a side of the bed to secure the bed against movement when the vehicle is in motion.

17. A method according to claim 16, further comprising unloading the bed from the vehicle comprising the steps of:
actuating said securing member to disengage the side of the bed;
activating said winch to allow the bed to roll down said support surface and to allow the bed to roll down said loading ramp until the bed is not supported by said support surface or said loading ramp; and
disengaging said cable from the bed once the bed is not supported by said support surface or said loading ramp.

18. A method according to claim 16, wherein said actuating step comprises laterally moving an arm against a side of the bed to secure the bed against movement when the vehicle is in motion.

19. A method according to claim 18, wherein said step of laterally moving an arm comprises pivoting the arm about a hinged attachment with an actuator for laterally moving said first arm to engage the side of the bed.

20. A method according to claim 16, wherein said activating step is controlled by a remote control.

21. A method according to claim 16, wherein said actuating step is controlled by a remote control.
